(19) United States
(12) Patent Application Publication
(10) Pub. No.: US 2015/0353236 A1
(43) Pub. Date: Dec. 10, 2015

(54) SMART PACKAGING AND RELATED TECHNOLOGIES

(71) Applicant: T+Ink, Inc., New York, NY (US)

(72) Inventors: John Gentile, Montclair, NJ (US); Terrance Z. Kaiserman, Loxahatchee, FL (US); Steven Martin, Cohen, NY (US); Anthony Gentile, New York, NY (US); Tayler Kaiserman, Brooklyn, NY (US); Adam Joffee, New York, NY (US)

(73) Assignee: T+Ink, Inc., New York, NY (US)

(21) Appl. No.: 14/616,304

(22) Filed: Feb. 6, 2015

Related U.S. Application Data
(60) Provisional application No. 61/937,023, filed on Feb. 7, 2014.

(51) Int. Cl. B65D 25/20; B65D 85/72; B65D 25/34; G06K 19/067

(52) U.S. Cl. CPC B65D 25/205; G06K 19/067; B65D 85/72; B65D 25/34

(57) ABSTRACT

Embodiments relating to packaging (e.g., food and/or beverage packaging) are described herein.

### RELATED APPLICATIONS

This application claims priority to U.S. Provisional Application No. 61/937,023, filed Feb. 7, 2014, which is incorporated herein by reference in its entirety.

### FIELD OF INVENTION

The present invention relates generally to packaging (e.g., food and/or beverage packaging) and certain embodiments relate, more particularly, to packaging incorporating one or more of the following features: electronics, a power source, sensors, illumination, and communication capable of sending and/or receiving information to enhance the value of the packaging.

### BACKGROUND OF INVENTION

Packaging (e.g., of food and liquid) has been used for thousands of years, from burlap and fibrous sacks to hold and transport powders and grain, to barrels, ceramics, and glass. With the advent of metal cans, paper, and plastic, packaging has undergone a revolution. Coupled with preservatives, pasteurization, and modern chemistry it is now possible to keep a wider variety of foods fresh and safe longer, and this has increased convenience and the quality of life in civilization.

With the coming of cheap electronics and printing technology it is now possible to create smart packaging, and thus we are at the threshold of the next packaging revolution. We can now interact with the user, handler, and purchaser of food and beverages in novel ways that permit tracking of purchases, and this can be used for inventory control, automatic re-ordering, and assessment of tampering, package breeching, spoilage due to moisture, mold, or animal infestation. And further, smart packaging containing lights, sound producing ability, different types of sensors and corresponding sensory inputs, smart electronics, and interaction between humans, smart devices, vending machines, coupled with wireless communication, the purchaser's experience can be both personalized and enhanced. Point of purchase personalized advertising, inducements, prizes, and a game-like environment can integrate at various psychological levels to positively reinforce brand loyalty and promote purchases.

### SUMMARY OF INVENTION

Embodiments of the present invention relate generally to packaging and, in some embodiments, to food and/or beverage packaging.

In one aspect, a smart package is provided. The smart package includes at least one battery and/or energy storage element and/or energy receiving element; an element configured to store information; an element configured to sense being touched; an element configured to display information and/or an element configured to generate light; an element configured to receive and/or transmit information; and circuitry electrically one or more elements of the package to one another.

In some embodiments, the smart package includes at least one sensor configured to sense a property of the smart package and/or contents of the smart package.

In some embodiments, the smart package contains electronics that can enable a user/purchaser to interact with the package and cause actions to happen either on the package itself or on a smart device like a smart phone or computer or a vending machine, or communicate or cause communication with a website where a data base might reside. For instance, a soda bottle or can or bag of chips can have the capability of being touched to a smart phone, having a code read, and the smart phone can take one or more actions based on the type of product within its proximity.

In some embodiments, the smart package can comprise one or more batteries and/or an energy storage element like a capacitor and/or can have the ability to receive energy electromagnetically and inductively if it is placed within an AC field, circuitry, a means of storing information, at least one means of sensing being touched in at least one location, at least one sensor, at least one means of displaying information and/or at least one means of generating light, and at least one means of receiving and/or transmitting information. The smart package can be applied to or incorporated within and/or on any of the following package types: a glass and/or plastic bottle, a can, a package, a bag, an envelop, a box, a cylinder, an applied label, a food wrapper, concentrate packages, post-mix systems comprising at least one package containing at least one component requiring the mixing of more than one component, an outer package and/or wrapper and/or containment system for containing multiple items. The above components can be a controlled volume of liquid separately contained and/or packaged within the item, and/or the liquid component can come from a source outside the item. The smart package is not limited to containment of food or beverages; it can be packaging and/or containment for any of the following including but not limited to animal food, grain, frozen or unfrozen meat, fish and other seafood, cleaning chemicals, reagent chemicals, industrial chemicals, pesticides, fertilizer, paint, solvents, coatings, inks, dyes, cement, glue, building materials, raw manufacturing materials, tools, machinery, weapons, ammunition, military inventory of any type, stored energy devices, minerals, toys, commercial products, electronics equipment, electronics components, clothing, apparel, accessories, biological samples and/or specimens, genetic material, animals, drugs, medicines, powders of any type, liquids of any type, solids of any type, gas of any type, living things, non-living things, fuels, medical waste, toxins, poisons, radioactive materials, books, data storage devices and/or systems, to name a few. The means by which light can be generated can be at least one LED and/or at least one RGB LED. At least one LED and/or RGB LED can be located on the bottom of a glass or plastic bottle containing liquid, and the liquid can be illuminated with a specific color or changing color pattern when on a display shelf and/or even when being consumed. This specific color and/or changing color pattern can be customized and/or customizable. The glass and/or plastic bottle can incorporate at least one fiber optic element and/or light pipe and/or edge-lit channel within the molded shape, and this can enable transmission and radiation of light from at least one location. The glass and/or plastic bottle can incorporate at least one reflective coating and/or surface which is illuminated and/or disperses light of at least one color. The reflective coating can be a dichroic mirror and/or surface. The smart package can receive color information and/or a custom light pattern designation so the circuitry can cause the creation of a specific color and/or custom light pattern. In a glass and/or plastic bottle, the liquid can be illuminated in at least one pattern of light. In this case, the liquid serves as a light transmission medium and/or a radiation medium, and further, the liquid stream while being poured and at a distance from the mouth of the bottle can also be illuminated. One or more single color LEDs and/or RGB LEDs can be imbedded and/or molded into plastic and can be located in the bottom, the side, or the lip of the bottle, or any combination thereof. There can also be at least one UV LED sheet that changes the design and/or colors in one or more locations. When multiple images on multiple surfaces are selectively illuminated, one can fade out as another fades in, thus producing an interesting and esthetically pleasing transition from one image to another. There can also be at least one sensor that can measure force and/or weight and thus provide a weight signal to be read and/or processed by the circuitry. This circuitry can generate data used for at least one of the following: calculating approximate calorie consumption, calculating approximate rate of calorie consumption, generating signals to display caloric and/or rate of caloric consumption, generating signals to be transmitted to another device and/or another smart food package and/or smart device and/or vending machine. At least one sensor can also measure internal pressure within said smart food package and thus provides a pressure signal to be read and/or processed by the circuitry, and this can subsequently indicate whether it is safe to open the bottle or not.

The smart package can also contain at least one touch code, which can be printed conductive ink on a package that can be read and decoded by a smart device like a smart phone, tablet, computer, or vending machine, and this can provide unique information about the product contained within the package. Suitable touch code configurations and techniques have been described in U.S. Pat. No. 8,497,850 and U.S. Patent Publication No. 20120125993 which are incorporated herein by reference in their entireties. The smart package can also have the ability to create sound, and the touch code can cause activation of a sequence of events which causes a custom sound to be produced. A typical sequence of events can be the acquisition of a touch code by a smart device, processing by the smart device to produce an action, the communication of data from the smart device back to the smart food package, or alternatively, the smart device can acquire a touch code, communicate data through a wireless network to a website, the website can processes the data, then communicate data from the website back through a wireless network to a smart device which can then communicate data in the form of actions to be taken back to the smart food package. The touch code can be on the bottom mold of a bottle, on the cap of the bottle, and/or on the side and/or label of a bottle. A touch code can be applied via a printing processes, an in-mold processes, a labeling processes, or master forming the bottle and/or can. Touch codes are printed with conductive ink when printed on a non conductive item like a plastic or glass bottle. When printed on a can which is metal, the touch code is the negative, printed as an insulator rather than a conductor because the can itself is a metal substrate and a conductor.

A touch code on a smart package can be in contact with and/or close proximity to another touch code on another package (for instance, one bag of chips held next to a soda) and/or in close proximity and/or in direct contact with a smart device, and this can cause a prize to be awarded. Alternatively, one smart package with touch code can be touched by a user, then another smart package can be touched, and so on, such that a particular touching sequence causes a sequence of events to occur which results in the awarding of at least one of the following: a prize, a gift, cash, an inducement, promotion, a discount for future purchases, points, jackpots, trips, travel miles, any of the above combined with any of the above offered from at least one other company. Another means of sensing can be at least one touch point (different than touch code) which performs the same function as a button pressing and/or switch closure, and this can be incorporated on a smart food package either alone or in conjunction with touch codes as well. Touch points can also be pressed in a sequence, like a combination lock, and the correct sequence can activate a winning action. The winning action can cause activation and illumination of a winning prize using one or more of the following: a UV LED, a light pipe, at least one LED, at least one RGB LED.

The smart package can also have a pen and/or marker containing a conductive ink, a visible ink, an invisible ink, or any combination. The marker can be used to draw a design and/or image upon a bottle or can, and the bottle or can then can be rolled across the a smart device screen for subsequent reading and decoding and transfer of design and/or image into the memory of the smart device. This design and/or image can be incorporated into the play pattern of interaction between any number of smart food packages, smart devices, vending machines, websites, and other people to create a fun interactive experience. An added feature can include the ability to illuminates a pattern of light when cap is removed and to extinguish the light when cap is on.

The smart package concept can extend to additional beverage related products including but not limited to coasters, hangtags, six-packs or other outer packaging, table tents, cups, beer cozies, cup holders.

A smart device can still decode the touch code properly when rotating the bottom or top of a bottle or can against the screen.

The conductive ink can be printed in a configuration such that a break in continuity senses package tampering, packaging failure, or unauthorized opening or a breech between interior environment and ambient, for example, if a bag of chips were opened. Touch codes and/or touch points can be used as inputs in the capacity of a game controller when used in conjunction with a screen capable of reading touch codes and/or a smart device capable of communicating with the smart food package. The smart package can be capable of determining the angle between and/or translation along the screen of a smart device and/or the pressing of touch points. The smart package can contain all the components necessary to receive power using magnetic resonant and/or magnetic coupling technology and/or induction and/or near field and/or RFID technology, and this can enable an integrated heating element to heat the contents of the smart package.

In another aspect, a package for containing dry foods is provided. The package comprises at least one second internal compartment contained within a first internal compartment.

In some embodiments, this aspect deals with environmental management and/or monitoring of the interior of a package or container, for example, one that contains dry food. The dry food can be any of but not limited to the following: grains, cereals containing any of but not limited to corn, wheat, oats, barley, sorghum, legumes, plantain, protienaceous materials, and also cooked products, baked products, roasted products, chips, deep fried products, extruded products, dry food, pellets, blends and/or mixtures containing at least one of the above. The smart package can be made of at least one of the following: a glass and/or plastic bottle, a can, package, bag, envelop, box, cylinder, applied label, food wrapper, concentrate packages, post-mix systems comprising at least one package containing at least one component requiring the mixing of more than one component, an outer package and/or wrapper and/or containment system for containing multiple items. The package can further comprise at least one second internal compartment, and there can be environmental communication between this second internal compartment and the interior environment of the smart dry food package where the dry food is contained and/or stored. This second internal compartment can contain a hydroscopic desiccant, and this hydroscopic desiccant can be food safe. The second internal compartment can contain at least one sensor exposed to the internal environment of the smart package, and this sensor that can sense humidity can be connected to the circuitry.

The package may not include any electronics in some embodiments. There can simply be a package, for example, that contains dry food which can be any of but not limited to the following: grains, cereals containing any of but not limited to corn, wheat, oats, barley, sorghum, legumes, plantain, protienaceous materials, and also cooked products, baked products, roasted products, chips, deep fried products, extruded products, dry food, pellets, blends and/or mixtures containing at least one of the above. There can be at least one second internal compartment, and there can be environmental communication between this second internal compartment and the interior environment of the first internal compartment in which the dry food is contained and/or packaged. The package, for example, for containing dry foods can be constructed from at least one of the following: a glass and/or plastic bottle, a can, package, bag, envelop, box, cylinder, applied label, food wrapper, concentrate packages, post-mix systems comprising at least one package containing at least one component requiring the mixing of more than one component, an outer package and/or wrapper and/or containment system for containing multiple items. This second internal compartment can contain a hydroscopic desiccant, and this hydroscopic desiccant can be food safe.

There can be another second internal compartment that contains a means for attracting and/or containing and/or eradicating unwanted insects and/or arthropods, such as mites or flour mites, beetles, and other animals that infect grain and flour. The package, for example, for containing dry foods can contain a means for attracting and/or containing and/or eradicating unwanted insects and/or arthropods, and this can contain at least one of the following: an ink containing talc and/or other food-safe material, and a chemical and/or food serving the function of bait. The package, for example, for containing dry foods and the other second internal compartment can contain a food-safe but attractive substance and/or bait for unwanted insects and/or arthropods and the environmental communication can be a plurality of openings configured in a funnel-like arrangement and/or series of trap doors arranged to permit easy migration of unwanted insects and/or arthropods from the package, for example, for containing the dry food into the second internal compartment but more difficult migration from the second internal compartment to the package for containing the dry food. In other words, it behaves somewhat like a lobster trap for insects and arthropods. This second internal compartment can contain a means for attracting and/or containing and/or eradicating unwanted insects and/or arthropods. This method of attracting and/or containing and/or eradicating unwanted insects and/or arthropods can be used equally well in either a smart food package containing electronics or a passive simple package for containing dry foods.

In one aspect and in certain embodiments, a smart package including conductive ink is provided. The conductive ink is printed upon a surface that can be placed and/or held in contact with the screen of a smart device and/or vending machine and/or device capable of sensing conducting and/or capacitive things and/or components and/or body parts.

The package can contain conductive ink to form the touch code, and this conductive ink can be printed upon a surface that can be placed and/or held in contact with the screen of a smart device and/or vending machine and/or device capable of sensing conducting and/or capacitive things and/or components and/or body parts. The conductive ink printed upon a surface can be configured in a unique shape and/or pattern that represents one of a multiplicity of states, and these states can be detected and/or uniquely differentiated by a smart device and/or vending machine and/or device capable of sensing conducting and/or capacitive things and/or components and/or body parts.

In one aspect, a spectrometer or color measurement device is provided. The spectrometer or color measurement device can measure and quantify the color of a sample material and communicate color information directly to a food and/or beverage containing package and/or smart food package.

In some embodiments, color information can be sent to the smart package so the circuitry can reproduce the color. This color can be quantified and resolved into its component parts using a spectrometer or color measurement device that can measure and quantify the color of a sample material and communicate the color information directly to a package (e.g., food and/or beverage containing package and/or smart food package).

In one aspect, an application on a smart device and/or computer and/or tablet is provided. The application can measure and quantify the color of a sample material and enable transmission of color information directly to a food and/or beverage containing package and or smart food package

A smart device can be equipped with an app and/or program that can be run on a smart device and/or computer and/or tablet that can measure and quantify the color of a sample material and enable transmission of color information directly to a package (e.g., food and/or beverage containing package and or smart food package).

In one aspect, a smart vending machine interface is provided. The interface comprises at least one capacitive touch point located on a front surface; at least one element configured to communicate and/or read QR codes and/or other optical images; and circuitry configured to decode and/or process at least one said touch point and/or said QR codes and/or other optical images.

In some embodiments, the smart vending machine interface comprises at least one capacitive touch point located on the front surface of the vending machine, at least one means to communicate and/or read QR codes and/or other optical images, circuitry to decode and/or process at least one touch point and/or QR codes and/or other optical images. The smart vending machine interface can also comprise at least one surface upon which images can be projected and/or at least one surface that changes an image. This surface that changes an image can be at least one LCD and/or LED display system. This surface can also be at least one image that is illuminated using UV light. When multiple images on multiple surfaces are selectively illuminated, one can fade out as another fades in, thus producing an interesting and esthetically pleasing transition from one image to another. The smart vending machine interface further comprises the ability to read touch codes from at least one smart food package. The touch codes can provide at least one of the following: activation for purchase, code verification, freshness data including but not limited to date of manufacture and/or expiration date. The touch codes and/or freshness data can initiate other communication methods to cause the transmission of data, and this can take the form of near field communication, RFID, blue tooth, and the data contains at least one of the following: smart food package interior environment information including but not limited to the presence of mold, bacterial and/or viral infection, humidity, toxins, animal life, and/or foreign chemicals.

The smart vending machine interface can also have the ability to access customer records, customized inducements and offerings, prizes, winning prizes, deals on other related items, products being sold, information about new product launches, advertising, customer profile and/or buying profile and/or purchase history, and/or other relevant information. Communication can occur between at least two of the following: the smart vending machine interface, a smart device, a smart (e.g., food and/or beverage) package, direct human contact via touching and/or speaking and/or placing printed material against the smart vending machine interface and/or smart device. The touch code can interact with the smart vending machine interface and/or smart device, and the smart device and smart vending machine interface can communicate with each other. There can also be a UV LED hood that can activate when the touch code and/or touch points on a smart (e.g., food and/or beverage) package are activated and the smart (e.g., food and/or beverage) package is placed within the UV LED hood, thus protecting eyes from harmful UV light, and this can cause to be illuminated a message on the smart (e.g., food and/or beverage) package. The touch code can be decoded to produce a unique code that has an associated number and/or value of points for use in conjunction with or without an app in redeeming products and or being used for other inducements. Stand alone coupons and/or printed offers on advertising pages in magazines and/or newspapers and/or other printed material and/or surfaces can be redeemed directly at vending machine using the touch code and/or QR encoding by placing the printed material against the face of vending machine in a designated touch code and/or optical reading area. The smart vending machine interface can further comprise RFID and/or near field technology to monitor the quantity of items contained within the vending machine. This monitoring can supplement self-knowledge of how many of each type of item has been dispensed, and this can be used to automatically reorder more inventory. The smart vending machine interface can also employ smart shelving technology to sense the presence of and types of products within the vending machine. The presence of and types of products within the vending machine can be used for inventory control, inventory management, and/or to reorder more inventory.

The smart (e.g., food and/or beverage) package embodiments can be employed on the packaging and shipment of cases of items. This outer package and/or wrapper and/or containment system for containing multiple items can sense how many items have been removed from a case and how many items remain. This information can be used for inventory control and/or reordering. The outer package and/or wrapper and/or containment system for containing multiple items can also contain a UV pen and/or flashlight and/or illuminator that can be used to illuminate any of the following on the smart package containing any individual item: hidden messages, codes, winning messages, prizes won, inducements, advertisement, website addresses for more information. The wrapper and/or containment system for containing multiple items can further comprise at least one printed battery that can apply power and/or supplemental power to at least one smart food package containing at least one item, and this causes at least one action to be taken. This action can be at least one of the following: display of a particular pattern of illumination that can be personalized and/or pre-programmed, the creation of sound, communication to a smart device, communication between one smart food package and another smart food package, wireless communication, near field and/or RFID communication, communication with a vending machine. The outer package and/or wrapper and/or containment system for containing multiple items can use touch code technology to provide at least one of the following: verification information, freshness information, reorder information.

A further addition to the smart package is the use of one of more smart packages in conjunction with a smart display, for example, a smart shelf. The smart display (e.g., smart shelf) comprises an area array of sensors capable of sensing the force and/or placement of objects and/or bumps upon objects and/or items when placed upon the smart display (e.g., smart shelf). The smart display (e.g., smart shelf) can thus read the presence or absence of an item on a smart display (e.g., smart shelf), and with sufficient spatial resolution a unique bump pattern on the bottom of a package can be read and the package identified. A plurality of items can be placed within an area and can be quantified to provide information pertaining to at least one of the following: verification information, freshness information, reorder information.

In another aspect, a smart item measurement system is provided. The system comprises a means to generate near field signals and/or RFID signals; a source to generate and receive near field signals and/or RFID signals; at least one smart food package capable of receiving said near field signals and/or RFID signals; a means for said at least one smart food package to transmit information back to said source to generate and receive near field signals and/or RFID signals; a means to assess the number and type of said at least one smart food package; and a means to communicate said number and type of said at least one smart food package to a central data processing station.

A smart item measurement system can comprise a means to generate near field signals and/or RFID signals, a source to generate and receive near field signals and/or RFID signals, at least one smart food package capable of receiving near field signals and/or RFID signals, a means for at least one smart food package to transmit information back to the source to generate and receive near field signals and/or RFID signals, a means to assess the number and type of smart (e.g., food) packages, and a means to communicate the number and type of smart food packages to a central data processing station. The central data processing station can be capable of generating a report that can be used for inventory control and automatic and/or computer-aided reordering, or a report can be generated that can be used for at least one of the following: inventory control and automatic and/or computer-aided reordering, verification information, and freshness information.

Although embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF DRAWINGS

FIG. 1A shows a can upon which a touch code negative is printed according to an embodiment.

FIG. 1B shows a plastic or glass bottle upon which touch codes are printed according to an embodiment.

FIG. 1C show a plastic cap upon which a touch code is printed according to an embodiment.

FIG. 1D shows a plastic or glass bottle with LEDs on the bottom according to an embodiment.

FIG. 1E shows a plastic or glass bottle upon which component are printed and/or applied according to an embodiment.

FIG. 2 shows a glass or plastic bottle with only a touch code printed on the bottom according to an embodiment.

FIG. 3 shows a bottle pouring with a stream of liquid illuminated according to an embodiment.

FIG. 4 shows a bottle with fiber optics and LEDs according to an embodiment.

FIG. 5 shows a bottle with reflective material and LEDs according to an embodiment.

FIG. 6 shows a bag of chips upon which components are printed and/or applied according to an embodiment.

FIG. 7A shows a block diagram of a generalized smart food package or system according to an embodiment.

FIGS. 7B-G show various typical subsets of the system depicted in FIG. 7A according to embodiments.

FIGS. 8A-C show a near field communication between a smart food package and smart devices according to an embodiment.

FIGS. 9A, B show a typical bidirectional communication flow chart between a smart food package and smart devices according to an embodiment.

FIGS. 10A, B show a typical bidirectional communication flow chart between smart food packages, smart devices, and a website according to an embodiment.

FIG. 11 shows a typical bidirectional communication flow chart between a smart food package, smart devices, a vending machine interface, and a website according to an embodiment.

FIG. 12 shows a typical communication between two smart food packages according to an embodiment.

FIGS. 13A, B show block diagrams of generalized system interconnection and bidirectional communication according to an embodiment.

FIG. 14 shows UV LED illumination of three different images according to an embodiment.

FIG. 15A shows a typical magazine smart ad according to an embodiment.

FIG. 15B shows a magazine smart ad being placed against a smart vending machine interface according to an embodiment.

FIGS. 16A-C show a plastic or glass bottle with a touch code being placed against different reading device touch screens according to an embodiment.

FIG. 17 shows a pen or marker and bottle upon which an image is drawn being rolled across the screen of a smart device according to an embodiment.

FIGS. 18A, B show a bag of chips upon which a trace of conductive ink is printed and the detection of a bag breech condition according to an embodiment.

FIG. 19 shows a food or product heating system according to an embodiment.

FIGS. 20A-C show containers with an interior compartment according to an embodiment.

FIGS. 20D-G show close-up depictions of the interior compartment and dry food containment interface according to embodiments.

FIG. 21 shows the sensing of humidity within a dry food container according to an embodiment.

FIG. 22A shows a typical case of items with a smart package with components called out according to an embodiment.

FIG. 22B shows a box bottom with pressure sensors to sense the presence of generalized items according to an embodiment.

FIGS. 22C, D show how a smart food package might be attached to the inside of smart case according to embodiments.

FIG. 23A, B show an RFID shelving system reading items in proximity, and a generalized item according to embodiments.

FIG. 24A, B show a flowchart for an RFID master controller and a generalized item being polled according to an embodiment.

### COMPONENTS

1 Smart Food Package
2 Bottle
3 Can
4 Lip of the bottle
5 Liquid
6 Bag of chips
7 Heat seal
8 Plastic or glass bottle
9 Generalized item
10 Touch code
11 Touch points
12 LEDs
13 Circuitry and/or microprocessor
14 Low Power Antenna
15 Fiber optic and/or light guide
16 Battery (printed or discrete)
17 Sound producing element (piezo, capacitive, dynamic, or other)
18 Capacitor
19 Magnetic field
20 light
21 an image or images
22 UV LED(s)
22A UV LED(s) on a first element
22B UV LED(s) on a second element
22C UV LED(s) on a third element
23 Glass or plastic plate with an image
23A Glass or plastic plate with an image on a first element
23B Glass or plastic plate with an image on a second element
23C Glass or plastic plate with an image on a third element
24 Humidity sensor
25 Reflective material
26 Pressure sensor
28 RFID shelving system
29 RFID transceiver antenna
30 Smart phone
31 Computer(s)
32 Vending machine
33 Smart vending machine interface
34 Website
35 Touch screen
36 Smart device
37 Designated area of signal acquisition
38 Single touch point
40 Internal compartment
41 conductive trace
42 breech of a package and/or break in conductive trace
43 Proteinaceous material and/or dry food
44 Smart dry food container
45 Dry food container
46 Interior exchange layer
48 Touch code negative
49 Package interior
50 Heating coil
51 Power antenna
52 Control electronics for magnetic coupling
53 Heating tray
54 Desiccant
55 Bait
56 Funnel-like hole(s)
57 Trap door(s)
58 Porous diffusion layer
59 Seal and/or method of closure
60 Magazine
61 Smart ads
62 QR code
65 Box or cereal box
66 pen and/or marker (containing at least one of the following inks: conductive, visible, invisible)
67 Activated item
68 unactivated item
69 RFID master
70 Smart case
71 Bottom of box
80 transmit with address
81 receive response ?
82 retry N times
83 response ?
84 increment address
85 log reply
86 increment address
87 max address reached ?
88 send report to master
89 clear log
90 reset address
91 beginning of the loop node
100 receive
101 my address ?
102 transmit response

### DETAILED DESCRIPTION

Embodiments relating to packaging (e.g., food and/or beverage packaging) are described herein.

In general, the smart packages described may be a food or beverage container and/or containment system such as any of the following including but not limited to a can, bottle, package, bag, box, cylinder, applied label, or food wrapper. As described further below, the smart packages described herein may include any of the following: an element configured to store and/or transform energy, an element configured to display information, an element configured to generate light, an element configured to sensing being touched in at least one location; an element configured to receive information; and at least one sensor configured to sense a property of the smart package and/or contents of the smart package, amongst others.

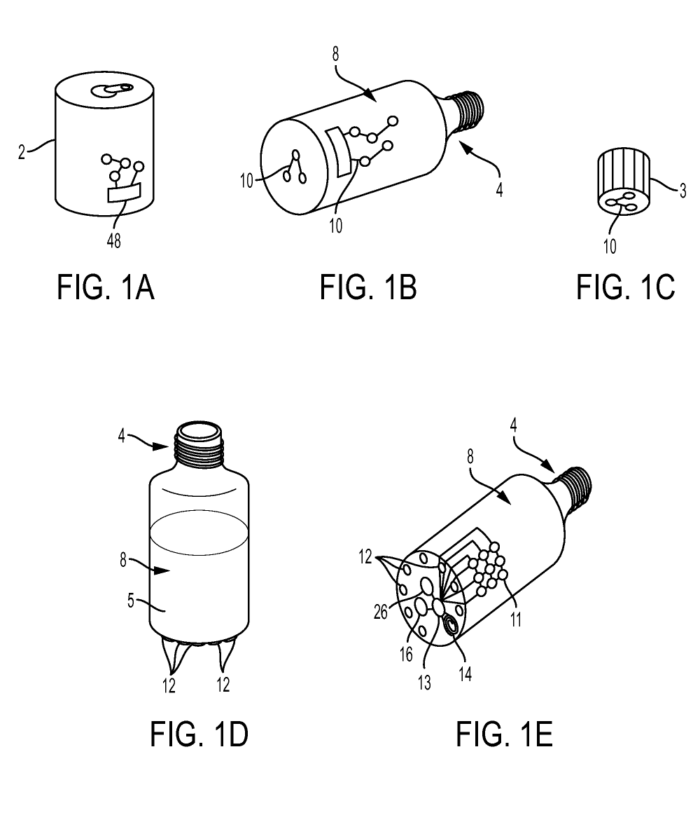

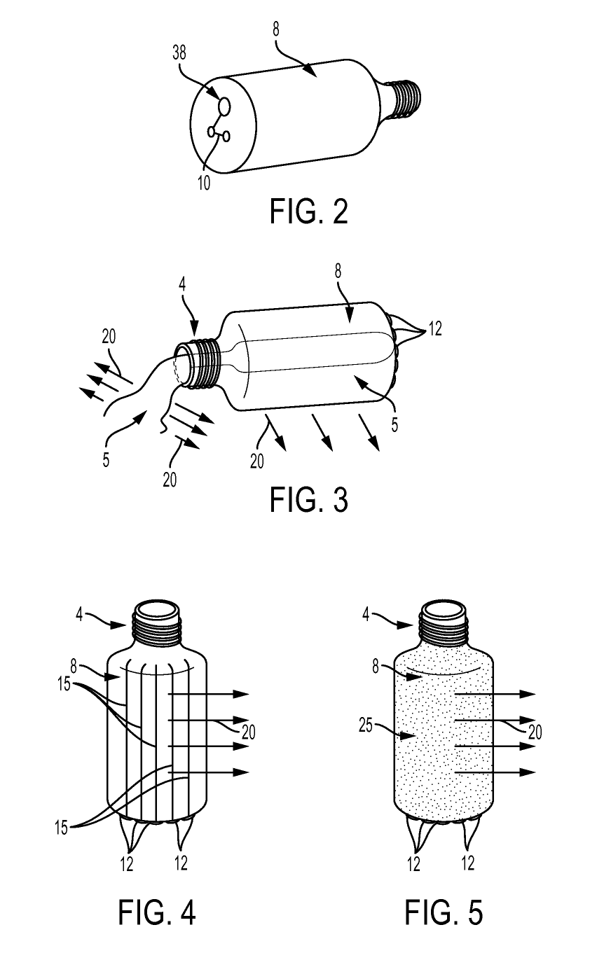

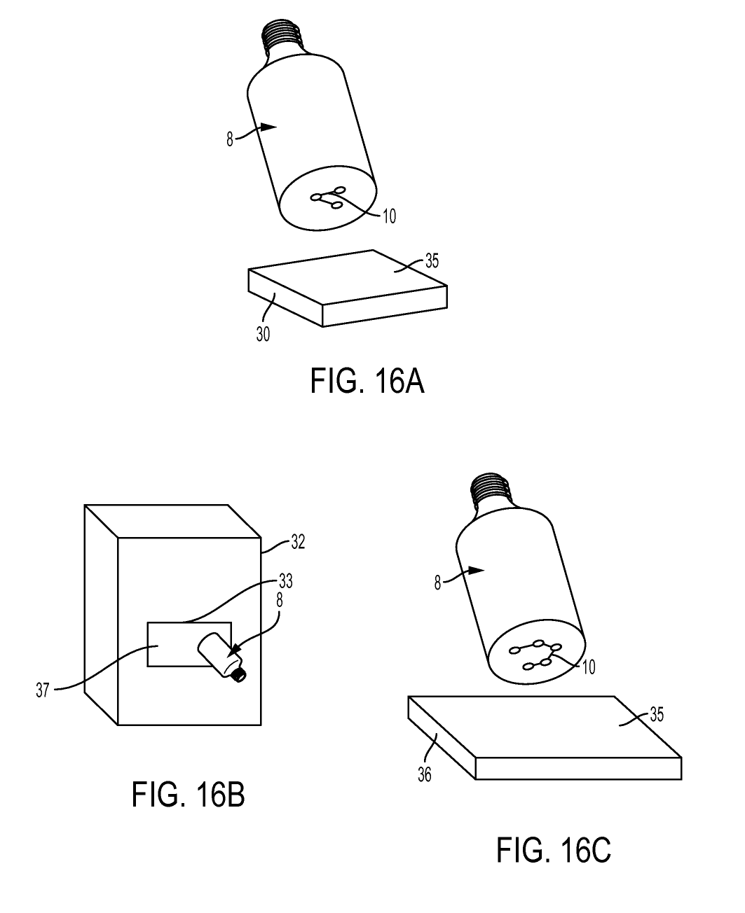

FIG. 1B shows a bottle 8 (e.g., plastic or glass) upon which one touch code 10 is printed on the bottom of and touch code 10 is also printed on the side of. FIG. 1C shows a plastic bottle cap 3 upon which a touch code 10 is printed. These touch codes are composed of conductive ink, and the conductive regions are sensed by the touch screen 35 (FIG. 16A) of a smart phone 30 (FIG. 16A) or a generalized smart device 36 (FIG. 16C), and this conductive ink simulates what human fingers do when they contact a touch screen 35. In this case, the touch code 10 is printed on an insulated material like plastic. FIG. 1A shows a can 2 upon which a touch code negative 48 is printed on the side of. In this case, the can 2 is conductive, so an insulated image, or touch code negative 48 is printed so the pattern transferred to the touch screen 35 is where the conductivity isn't as opposed to where it is when printed on an insulating material. So when printing on an insulator the conductive touch code 10 is printed and when printing upon a metal surface a touch code negative 48 is printed. FIG. 1D shows a plastic or glass bottle 8 with LEDs 12 attached to the bottom to illuminate the liquid 5 contained within. FIG. lE shows a plastic or glass bottle 8 upon which component are printed and/or applied, and the lip of the bottle 4 is shown. Shown are LEDs 12, circuitry and/or microprocessor 13, a battery 16, an antenna 14 for unidirectional or bidirectional communication with other things, touch points 11 that function like buttons or switches and can be used to input data to the circuitry and/or microprocessor 13 by pressing with fingers, and a pressure sensor 26 which can sense when the plastic or glass bottle 8 is upright and on a flat surface and has some quantity of liquid 5 contained within. FIG. 2 shows a glass or plastic bottle 8 with only a touch code 10 printed on the bottom. The touch code 10 can function as a stand-alone printing of conductive ink when used as an extension of the human fingers or hand, which when pressed against the touch screen 35 of a smart device 36 as shown in FIGS. 16A-C, can read multiple printed areas in the same way as multiple fingers touching a touch screen 35 can be read. Touch codes are therefore a useful way to encode data, with the number of unique codes being only dependant upon the number of unique positions that can be ascertained by the software processing the touch codes in any generalized smart device 36. If, for example 30 unique positions can be quantified for a single touch point 38 on the surface of a touch screen 35, and three single touch points are employed in producing a total touch code, then (30!-(30-3)!) or 24,360 number of unique codes are theoretically possible. Obviously as the area goes up and the quantification resolution increases along with the number of touch points, the number of states can achieve very large numbers, and thus it is possible to encode information such as product type, date of manufacture, lot number, item number, customer or location being shipped to, specials being offered, prizes or jackpot winning item to name a few. Many things can be encoded even before conventional memory is used to store vast quantities of information.

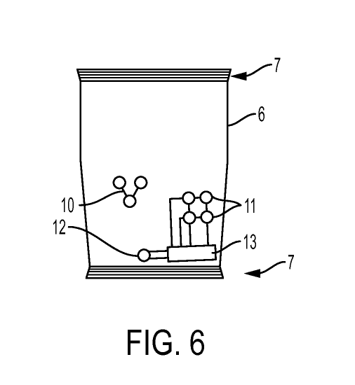

FIG. 3 shows a plastic or glass bottle 8 pouring a stream of liquid 5 being illuminated by LEDs 12, transmitting light 20 both through and out of the liquid 5. As shown, light 20 passes through the liquid 5 contained within the plastic or glass bottle 8, and the liquid 5 pours out the lip of the bottle 4 and, because the liquid 5 is behaving like a light pipe, light 20 can continue to radiate from the pouring stream of liquid 5. FIG. 4 shows a plastic or glass bottle 8 with LEDs 12 on the bottom and fiber optic and/or light guide 15 molded along the sides to transmit light 20 from the LEDs 12. This enables light 20 to both be transmitted and radiated up the sides of the plastic or glass bottle 8. FIG. 5 shows a plastic or glass bottle 8 with LEDs 12 on the bottom and with reflective material 25 being the mechanism to reflect and radiate light 20. FIG. 6 shows a bag of chips 6 upon which components are printed and/or applied. Shown is the bag of chips 6, the heat seal 7 on both the bottom and top of the bag of chips 6, circuitry and/or microprocessor 13, touch points 11, LEDs 12, and touch codes 10. This makes the bag a device data can be entered from, a means of display or lightshow-like patterns, and a means of possessing a unique code.

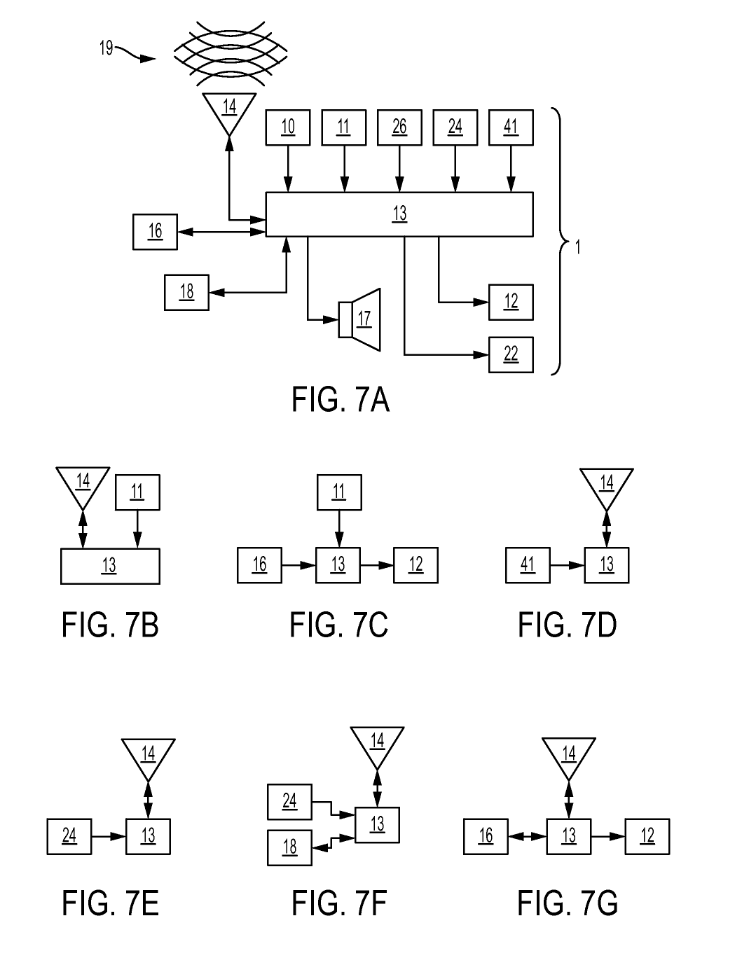

FIG. 7A shows a block diagram of a generalized smart food package 1. Shown is the circuitry and/or microprocessor 13, a low power antenna 14 for unidirectional or bidirectional communication, a battery 16 for storage of power (note bi-directionality thus enabling battery 6 to both discharge and charge should power be harvestable from the low power antenna 14), a capacitor 18 for charge storage (should a capacitor be possible to take the place of the battery 16), a touch code 10, touch points 11, at least one pressure sensor 26, at least one humidity sensor 24, at least one conductive trace 41, one or more visible LEDs 12, one or more UV LEDs 22, and a sound producing element 17. A large number of subsets can be composed from the generalized smart food package 1 depending on the application and customer needs. A representative few are depicted, but the scope of the invention should not be limited to the following examples. FIG. 7B depicts a block diagram of circuitry and/or microprocessor 13 connected to low power antenna 14 and touch points 11. FIG. 7C depicts a block diagram of circuitry and/or microprocessor 13 connected to touch points 11, one or more LEDs 12, and battery 16. FIG. 7D depicts a block diagram of circuitry and/or microprocessor 13 connected to conductive trace 41 and low power antenna 14. FIG. 7E depicts a block diagram of circuitry and/or microprocessor 13 connected to low power antenna 14 and humidity sensor 24. FIG. 7F depicts a block diagram of circuitry and/or microprocessor 13 connected to low power antenna 14 humidity sensor 24 and capacitor 18. FIG. 7G depicts a block diagram of circuitry and/or microprocessor 13 connected to low power antenna 14, battery 16, and one or more LEDs 12.

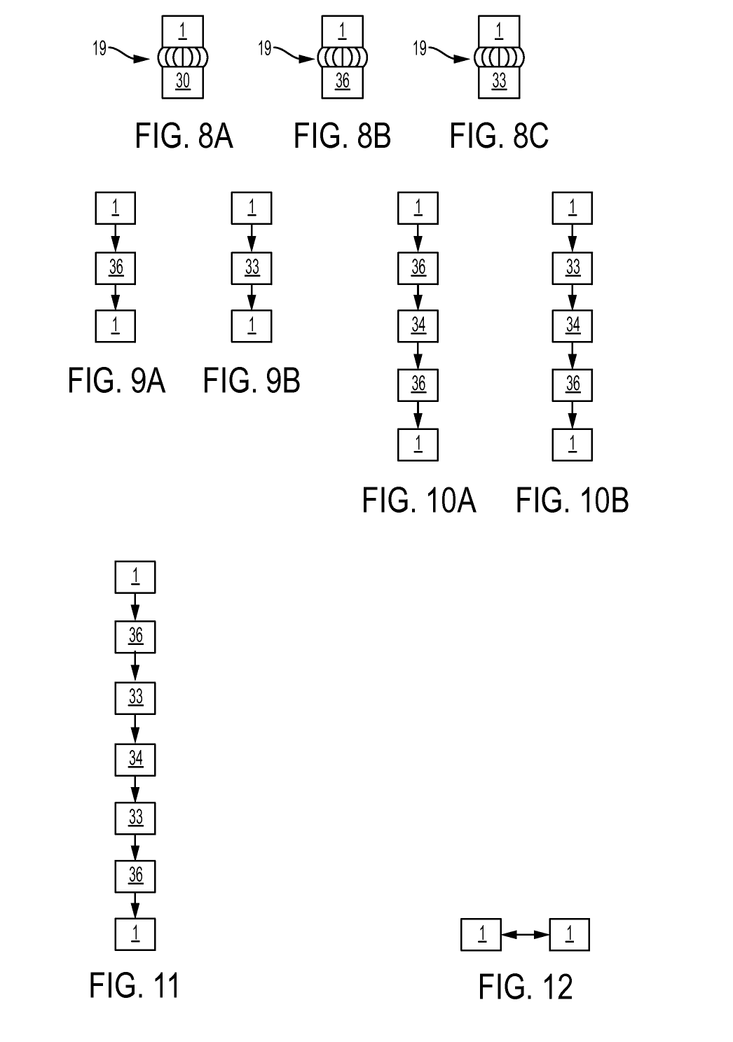

FIG. 8A shows a near field communication via magnetic field 19 between a smart food package 1 and smart phone 30. FIG. 8B show a near field communication via magnetic field 19 between a smart food package 1 and a generalized smart device 36. FIG. 8C show a near field communication via magnetic field 19 between a smart food package land a smart vending machine interface 33.

FIG. 9A shows a typical communication flow chart whereby a smart food package 1 communicates with a smart device 36, the smart device 36 processes information, then communicates back to the same smart food package 1. This effectively makes the smart food package 1 a dumb terminal, relying on a pre-existing program or app to reside within the smart device 36 to both communicate with the smart food package 1 and process the information properly. FIG. 9B shows a typical communication flow chart whereby a smart food package 1 communicates with a smart vending machine interface 33, the smart vending machine interface 33 processes information, then communicates back to the same smart food package 1.

FIG. 10A shows a flow chart whereby a smart food package 1 communicates with a smart device 36, the smart device 36 via a wireless connection communicates with the internet and subsequently a website 34, and in the website 34 a data base is stored and processing occurs that may be unique to the customer, the region, specials being offered, prizes, discounts, points, or any number of inducements that can be dynamically changing depending on the marketing strategy. The website 34 can then generate responses transmitted back to the smart device 36, and the smart device 36 can then communicate back the smart food package 1. Alternatively, FIG. 10B shows a flow chart whereby a smart food package 1 communicates with a smart vending machine interface 33, the smart vending machine interface 33 via a wireless connection communicates with the internet and subsequently a website 34, and in the website 34 a data base is stored and processing occurs as above, the website 34 can then generate responses transmitted back to the smart vending machine interface 33, and the smart vending machine interface 33can then communicate back the smart food package 1. FIG. 11 shows a flow chart whereby a smart food package 1 communicates with a smart device 36, the smart device 36 communicates via a wireless connection and/or nearfield communication and/or Bluetooth with a smart vending machine interface 33, the smart vending machine interface 33 via a wireless connection communicates with the internet and subsequently a website 34, and in the website 34 a data base is stored and processing occurs as above, the website 34 can then generate responses transmitted back to the smart vending machine interface 33, and the smart vending machine interface 33 communicates via a wireless connection and/or nearfield communication and/or Bluetooth to the smart device 36 which then communicates back to the smart food package 1. FIG. 12 shows a typical communication between one smart food package 1 and another smart food package.

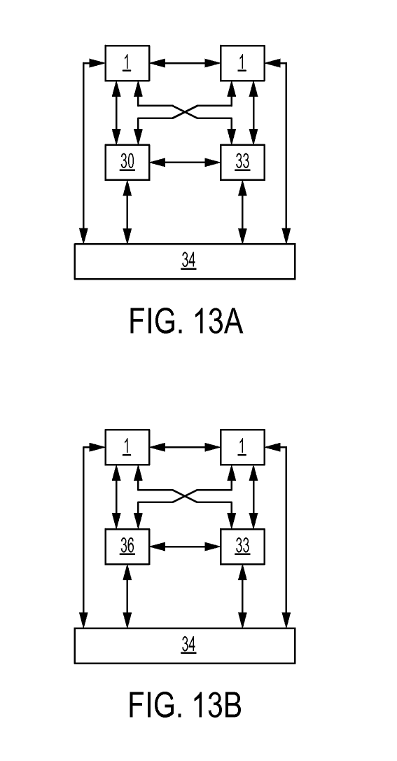

FIG. 13A and shows a block diagram of generalized system interconnection between a smart food package 1 and another smart food package 1, both with the ability to communicate with a smart phone 30 and a smart vending machine interface 33, and the smart phone 30 can connect to both a website 34 and a smart vending machine interface 33, and the smart vending machine interface 33 can connect to both a website 34 and the smart phone 30. All connections are bidirectional, so one can go in any path through any number of communications. Alternatively, FIG. 13B, shows a block diagram of generalized system interconnection between a smart food package 1 and another smart food package 1, both with the ability to communicate with a smart device 36 and a smart vending machine interface 33, and the smart device 36 can connect to both a website 34 and a smart vending machine interface 33, and the smart vending machine interface 33 can connect to both a website 34 and the smart device 36. All connections are bidirectional, so one can go in any path through any number of communications.

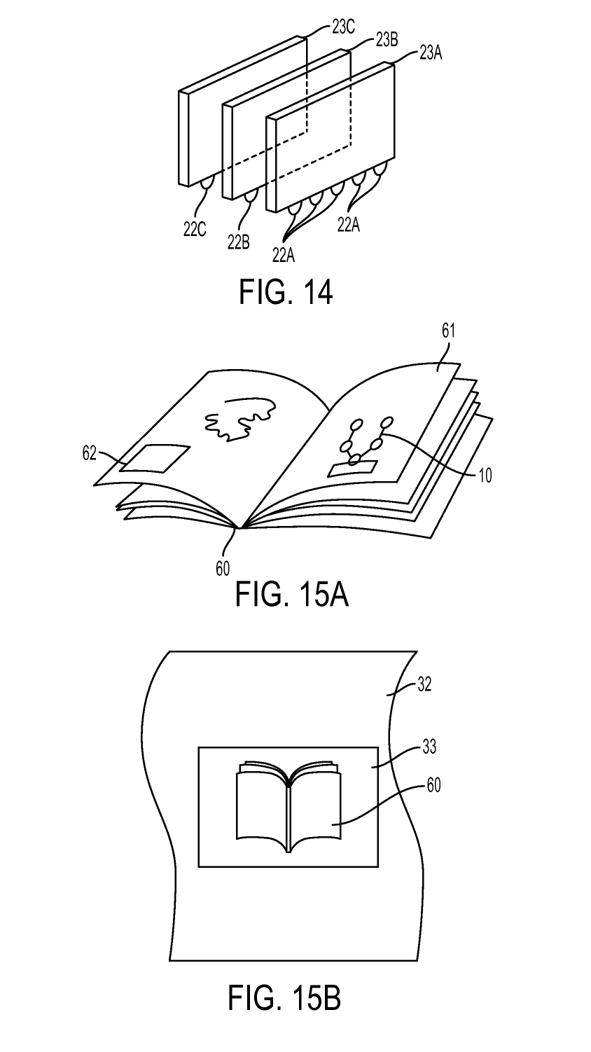

FIGS. 14A, B, and C show UV LED illumination of three different images. UV LED(s) on a first element 22A are used to illuminate glass or plastic plate with an image on a first element 23A. UV LED(s) on a second element 22B are used to illuminate glass or plastic plate with an image on a second element 23B. UV LED(s) on a third element 22C are used to illuminate glass or plastic plate with an image on a third element 23C. Depending upon which bank of UV LEDs are illuminated, the corresponding image can be illuminated and seen.

FIG. 15A shows a typical smart magazine ad or smart ad 61 employing a touch code 10which can be placed against a smart vending machine interface 33 as shown in FIG. 15B. Not shown would be the same smart ad 61 employing touch code 10 to be read by a smart phone 30 or a smart device 36 or any device with a touch screen 35. The smart ad 61 can also employ a QR code 62 and can be read in the smart vending machine interface 33 area of a vending machine 32.

FIG. 16A shows a plastic or glass bottle 8 with touch code 10 being placed against the touch screen 35 of a smart phone 30. FIG. 16B shows a plastic or glass bottle 8 with touch code 10 being placed against the touch screen 35 of a smart vending machine interface 33 within the designated area of signal acquisition 37 located on a vending machine 32. FIG. 16C shows a plastic or glass bottle 8 with touch code 10 being placed against the touch screen 35 of a generalized smart device 36.

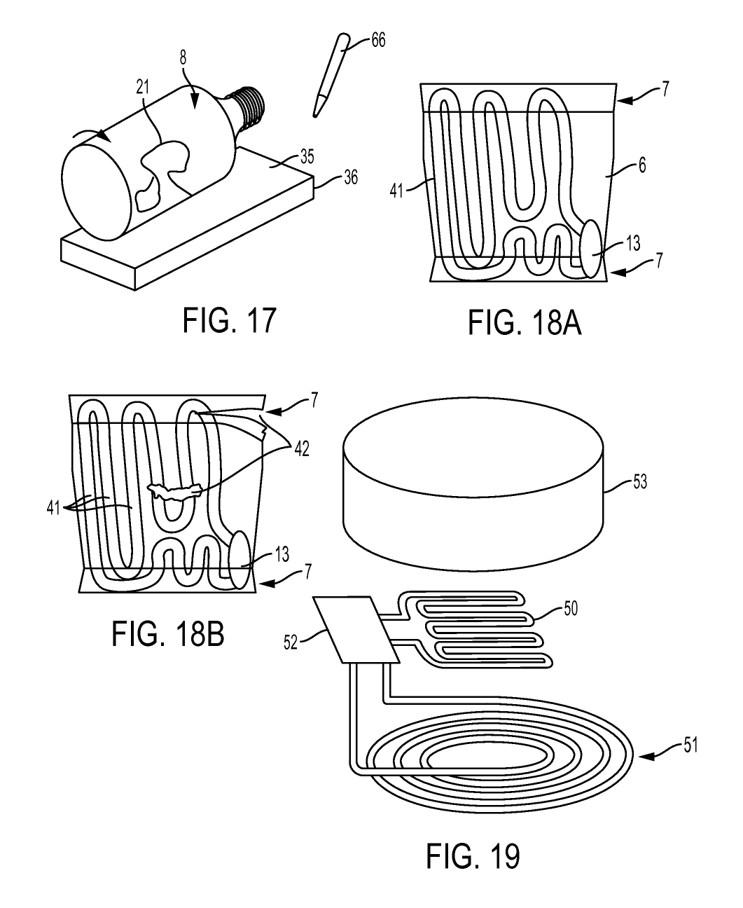

FIG. 17 shows a bottle 8 upon which an image or images 21 are drawn, and this bottle 8 is being rolled across the touch screen 35 of a smart device 36. The image or images 21 are drawn upon the surface using a pen and/or marker 66, and this contains at least one of the following inks: conductive, visible, or invisible.

FIG. 18A shows a bag of chips 6 upon which a conductive trace 41 or ink is printed. The serpentine pattern covers the area of the bag of chips 6 including the top and bottom area of the heat seal 7. The conductive trace 41 emanates from and terminates within the circuitry and/or microprocessor 13. FIG. 18B shows a breech of a package and/or break in conductive trace 42 in the area of the top heat seal 7 as might be experienced if a vandal opened the bag of chips 6 in a store. Also shown is another breech of a package and/or break in conductive trace 42 in the middle of the bag of chips 6 as might be created by a sharp object. Both breech conditions can be detected by a break in continuity of conductive trace 41 and can be detected by the circuitry and/or microprocessor 13.

FIG. 19 shows a food heating system which employs magnetic resonant and/or magnetic coupling technology. Not shown is the source of a high frequency power antenna producing a strong magnetic field, as would be generated by a high current AC waveform passing through a coil acting as a transformer primary. The transformer secondary is represented in FIG. 19 as the power antenna 51, and this feeds the control electronics for magnetic coupling 52. This in turn feeds heating coil 50, which is a low resistance conductive element that can deliver enough heat to effectively heat the heating tray 53 in which is placed the food and/or material being warmed.

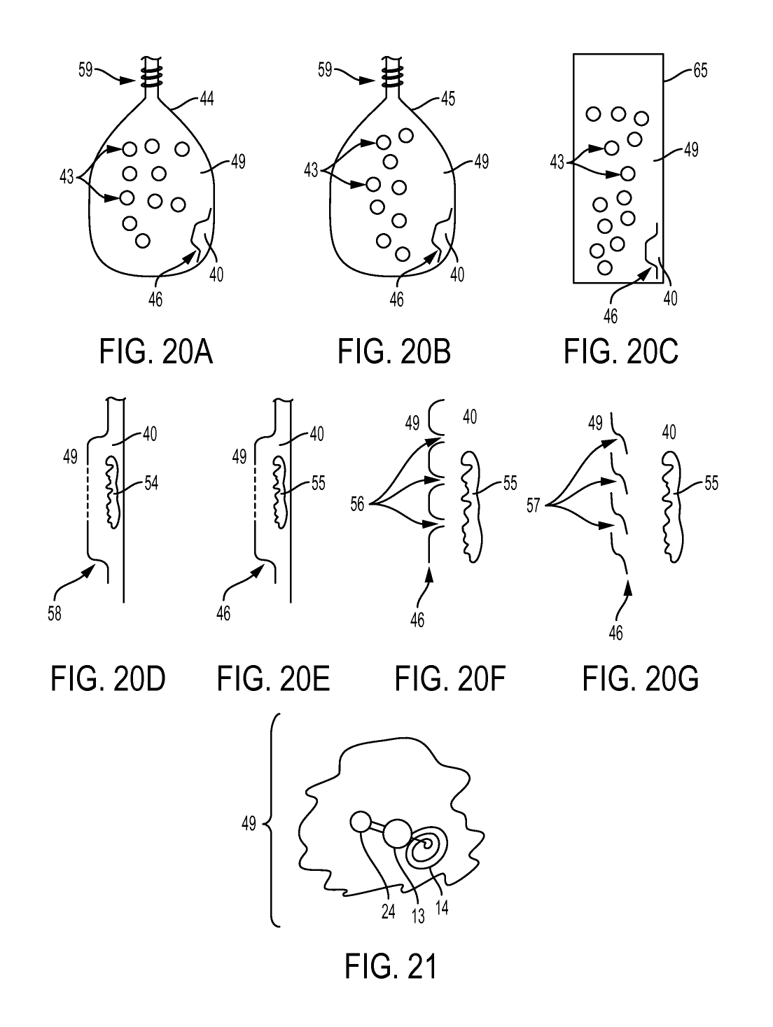

FIGS. 20A-C show containers with an interior compartment. FIG. 20A shows a smart dry food container 44 which contains proteinaceous material and/or dry food 43, such as dog food or grain or any other dry product that can be or not be eaten. The smart dry food container 44 contains a smart food package 1. The proteinaceous material and/or dry food 43 is contained within the package interior 49. Within the package interior 49 is located a second internal compartment 40, and an interior exchange layer 46 separates the internal compartment 40 from the package interior 49. FIG. 20B shows a dry food container 45 which contains proteinaceous material and/or dry food 43, such as dog food or grain or any other dry product that can be or not be eaten. The dry food container 45 is just a bag and contains no intelligence. The proteinaceous material and/or dry food 43 is contained within the package interior 49. Within the package interior 49 is located a second internal compartment 40, and an interior exchange layer 46 separates the internal compartment 40 from the package interior 49. FIG. 20C shows a box or cereal box 65 which contains proteinaceous material and/or dry food 43, such as dog food or grain or any other dry product that can be or not be eaten. The cereal box 65 can either contain a smart food package 1 or it can have no intelligence. The proteinaceous material and/or dry food 43 is contained within the package interior 49. Within the package interior 49 is located a second internal compartment 40, and an interior exchange layer 46 separates the internal compartment 40 from the package interior 49.

FIG. 20D shows a close up cross section of the internal compartment 40 separated from the package interior 49 by a porous diffusion layer 58. Within the internal compartment 40 is contained a package of desiccant 54. Diffusion layer 58 separates the desiccant 54 from coming in contact with the proteinaceous material and/or dry food 43, but exchange of gas permits a moisture gradient to be maintained so moisture can be absorbed from the package interior 49. FIG. 20E shows a close up cross section of the internal compartment 40 separated from the package interior 49 by an interior exchange layer 46. In this case, the internal compartment 40 contains bait 55 that can be attractive to insects and/or arthropods such as mites and flour beetles and other undesirable animals. FIG. 20F shows a close up cross section of the internal compartment 40 separated from the package interior 49 by an interior exchange layer 46. A quantity of bait 55 is located within the internal compartment 40. Within interior exchange layer 46 are located a plurality of funnel-like holes 56 in which animal migration is easier from the package interior 49 to the internal compartment 40 than from the internal compartment 40 to the package interior 49. And another embodiment of this concept is FIG. 20G, which shows a close up cross section of the internal compartment 40 separated from the package interior 49 by an interior exchange layer 46. A Quantity of bait 55 is located within the internal compartment 40. Within interior exchange layer 46 are located a plurality of trap doors 57 in which animal migration is easier from the package interior 49 to the internal compartment 40 than from the internal compartment 40 to the package interior 49.

FIG. 21 shows the sensing of humidity within a dry food container. Shown is the package interior 49, circuitry and/or microprocessor 13, a low power antenna 14, and humidity sensor 24. Other embodiments might employ a capacitor 18 and/or a battery 16, but the key feature is that the humidity sensor 24 be capable of enabling measurements of the package interior 49 so that if the moisture level gets too high a fault condition can be signaled.

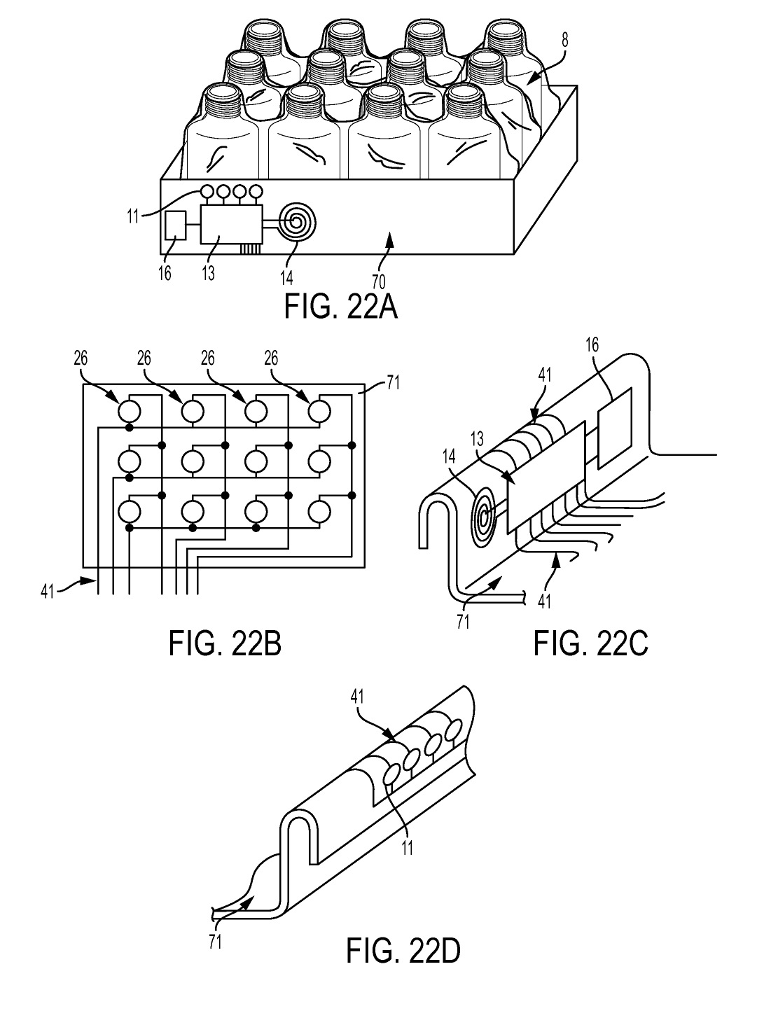

FIG. 22A shows a typical smart case 70 of at least one plastic or glass bottle 12, in this case there are twelve bottles, but they could be at least one generalized item 9 of any type. In the case is shown circuitry and/or microprocessor 13, a battery 16, a low power antenna 14, and touch points 11 from which a person can press buttons to activate functions. FIG. 22B shows seven conductive traces 41 which form a 3×4 matrix of pressure sensors 26 located on the bottom of the box 71. Each pressure sensor 26 would sense the presence of a plastic or glass bottle 8 or any generalized item 9. FIG. 22C shows a view of the box interior 71 showing the circuitry and/or microprocessor 13, a battery 16, a low power antenna 14, and conductive traces 41 leading to the touch point 11 shown in FIG. 22D as well as the conductive traces 41 leading to the matrix of pressure sensors shown in FIG. 22B.

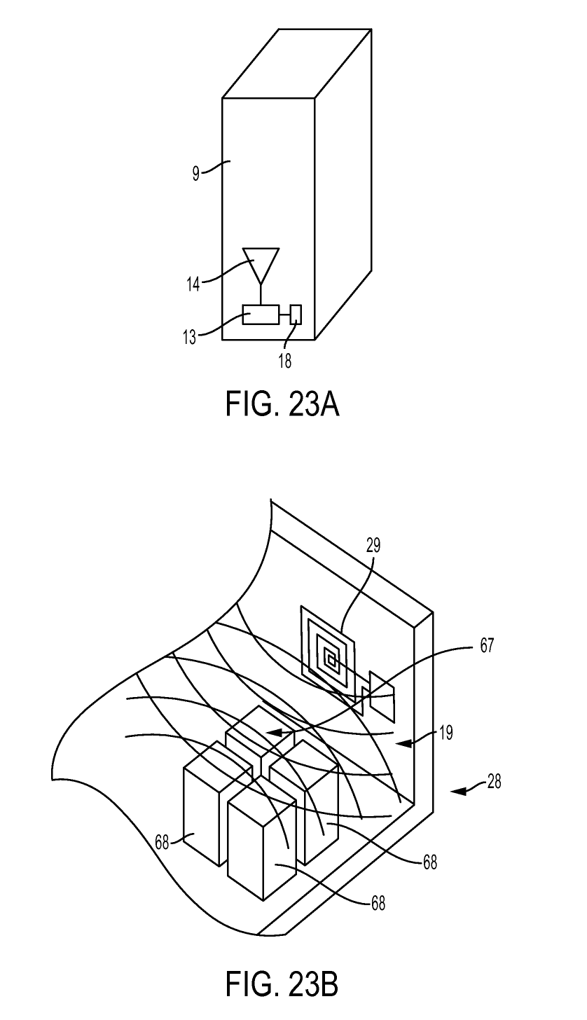

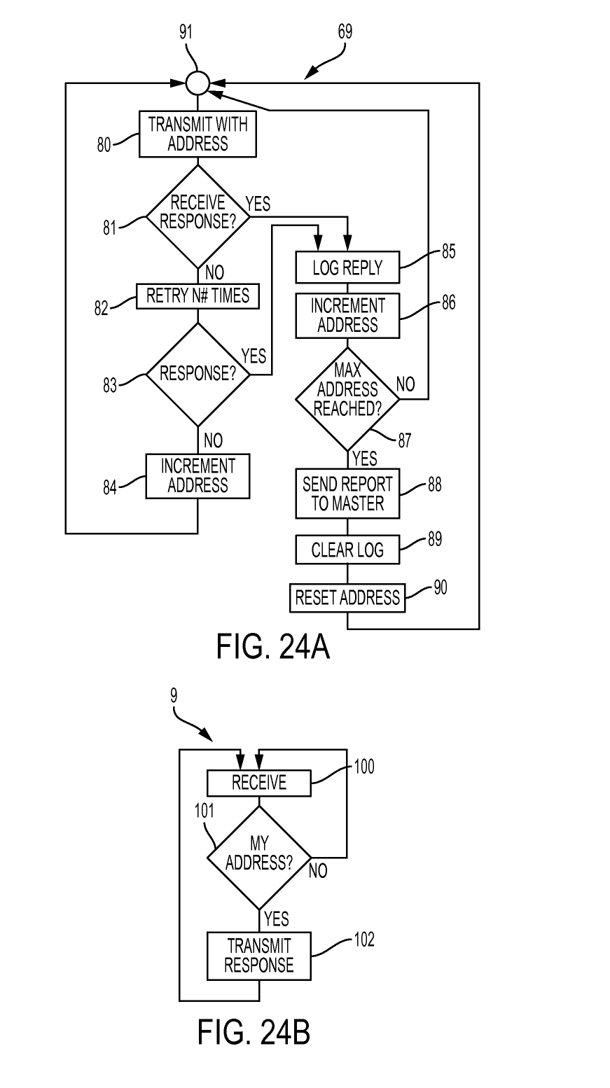

FIG. 23A shows a generalized item 9 being used in a type of RFID smart shelving system 28 (FIG. 23B). Shown is the circuitry and/or microprocessor 13, a capacitor 18, a low power antenna 14. FIG. 23B shows an array of generalized items 9, three of which are unactivated items 68 and one of which is an activated item 67. Shown is the RFID transceiver antenna 29, which both transmits a signal in the form of a magnetic field 19 which can be modulated in a multiplicity of ways, and an activated item then transmits a signal back (in the form of a magnetic field 19) to the RFID transceiver antenna 29 which then acts as a receiving antenna. While there are many ways to do this, one embodiment involves having all the generalized items 9 having pre-programmed addresses, of which can number in the tens of millions. When in transmission mode, the RFID transmitter sends a signal in which is encoded an address. If the generalized item 9 senses its own unique address, it responds by transmitting a signal which the RFID transceiver antenna 29 receives, and this event is then logged. All generalized items that are not being addressed will not respond until each respective generalized item sees its unique address. In this manner, conflicts are avoided. A simplified flowchart for this process is shown in FIG. 24A for the RFID master 69 and for the generalized item 9. The RFID master transmits a modulated signal, transmit with address 80. If a response is received from the generalized item 9, (receive response ?, 81), then the response is logged (log reply, 85) because this generalized item 9 is present. If no response is received, there could be a weak signal or interference, so the RFID master 69 will retry some number of times (retry N times, 82) until convinced that the generalized item 9 with the address being polled is not there. If a response is received (response ?, 83), then the presence of the generalized item 9 is logged (log reply, 85), and if no response is received, the address is incremented (increment address, 84) and the program returns to the beginning of the loop node 91. If a response is logged (log reply, 85) the address is incremented (increment address, 86), and a test is made to see if the maximum address has been reached (max address reached ?, 87). For instance, if there were only a maximum of 10,000 items to be polled as inventory is replaced, there is no need to count beyond 10,000 addresses for 10,000 generalized items 9, so when the RFID master counts to 10,000, it would restart at address 0 and begin counting again. If the maximum address is not reached the program jumps to the beginning of the loop node 91and it continues. If the maximum address has been reached, the RFID master 69 sends a report to a master computer (send report to master, 88), the log in the RFID master 69 is cleared (clear log, 89) in preparation for another pass to check all the generalized items, which will decrease in numbers as items are bought, the address is reset back to zero (reset address, 90), and the program returns to the beginning of the loop node 91 and the process repeats. FIG. 24B shows the basic program that would run in the generalized item 9 smart food package. A modulated signal would be received (receive, 100). A test would be performed to see if this address is its programmed address (my address ?, 101). If the address received does not match, the program goes back to the top and keeps listening (receive, 100). If the address does match, it transmits a response (transmit response, 102), and this tells the RFID master 69 that this generalized item 9 is still on the shelf. There are may ways to implement this basic function.

Further Description

Item: may be, for example, a product to be sold or handled contained within at least one of the following: a glass and/or plastic bottle, a can, package, bag, envelop, box, cylinder, applied label, food wrapper, concentrate packages, post-mix systems comprising at least one package containing at least one component requiring the mixing of more than one component.

Items may be, for example, more than one item of the above, either contained within the same type of container or more than type of container.

Points: may be, for example, an internal value or representation of money that can be redeemed and/or used for discounts, prizes, cash, or in any way valued

Smart device: may be, for example, any of the following that can employ a touch screen that can be activated by a touch code and/or human touch and/or capacitive element and/or conductive element including but not limited to: a smart phone, Iphone, Ipad, Android, a computer, a tablet, a reader, a vending machine.

Magnetic resonant and/or magnetic coupling technology may be, for example, similar to near field or RFID technology except for power applications where more power transfer is needed than that which can be transferred from near field or RFID transmitters, and this could be used for functions like charging batteries on portable devices and/or heating applications. This involves the creation of a high frequency AC current flowing in an antenna and/or coil and/or inductor or inductive element that can be printed and/or deposited on a substrate but can also be a wire, and this antenna and/or coil and/or inductor forms the primary of an air core transformer. The transformer secondary is an antenna and/or coil and/or inductor located within a receiving device, usually as close as possible to the primary, and this can receive power from the transformer primary when within the electromagnetic field of the primary. Power from the secondary can be directly used and/or converted to a more convenient form such as that which involves rectification into at least one DC voltage source and/or transformation to at least one other AC voltage and/or frequency.

1. A smart package comprising:
at least one battery and/or energy storage element and/or energy receiving element;
an element configured to store information;
an element configured to sense being touched;
an element configured to display information and/or an element configured to generate light;
an element configured to receive and/or transmit information; and
circuitry electrically one or more elements of the package to one another.

2. The smart package of claim 1, further comprising at least one sensor configured to sense a property of the smart package and/or contents of the smart package;

3. The smart package of claim 1, wherein the package is a beverage package or a food package.

4. The smart package of claim 1, wherein said smart food package is applied to or incorporated within and/or on any of the following packages: a glass and/or plastic bottle, a can, a bag, an envelope, a box, a cylinder, an applied label, a food wrapper, a concentrate package, post-mix systems comprising at least one package containing at least one component requiring the mixing of more than one component, an outer package and/or wrapper and/or containment system for containing multiple items.

5. The smart of claim 4, wherein said more than one component is a controlled volume of liquid separately contained and/or packaged within the item and/or said liquid comes from a source outside said item.

6. The smart package of claim 1, wherein the package is packaging and/or containment for any of the following: animal food, grain, frozen or unfrozen meat, fish and other seafood, cleaning chemicals, reagent chemicals, industrial chemicals, pesticides, fertilizer, paint, solvents, coatings, inks, dyes, cement, glue, building materials, raw manufacturing materials, tools, machinery, weapons, ammunition, military inventory, stored energy devices, minerals, toys, commercial products, electronics equipment, electronics components, clothing, apparel, accessories, biological samples and/or specimens, genetic material, animals, drugs, medicines, powders, liquids, solids, living things, non-living things, fuels, medical waste, toxins, poisons, radioactive materials, books, data storage devices and/or systems.

7. The smart package of claim 1, wherein said element of generating light is at least one LED and/or at least one RGB LED.

8. The smart package of claim 7, wherein said at least one LED and/or at least one RGB LED is located on the bottom of a said glass and/or plastic bottle containing liquid and said liquid is illuminated with a specific color and/or changing color pattern when on a display shelf and/or when being consumed.

9. The smart package of claim 8, wherein said specific color and/or changing color pattern is customized and/or customizable.

10. The smart package of claim 8, wherein said glass and/or plastic bottle incorporates at least one fiber optic element and/or light pipe and/or edge-lit channel within the molded shape to enable transmission and radiation of light from at least one location.

11. The smart package of claim 8, wherein said a glass and/or plastic bottle incorporates at least one reflective coating and/or surface which is illuminated and/or disperses light of at least one color.

12. The smart package of claim 11, wherein said reflective coating is a dichroic mirror and/or surface.

13. The smart package of claim 1, wherein said at least one element configured to receive and/or transmit information causes to be received color information and/or a custom light pattern so said circuitry can cause at least one element of generating light to create a specific color and/or said custom light pattern.

14. The smart package of claim 8, wherein said glass and/or plastic bottle enables liquid to be illuminated in at least one pattern of light.

15. The smart package of claim 14, wherein said liquid to be illuminated uses said liquid as a light transmission and/or radiation medium, and further that said liquid stream while being poured and at a distance from the mouth of said glass and/or plastic bottle is illuminated in said at least one pattern of light.

16. The smart package of claim 7, wherein said at least one LED and/or at least one RGB LED is imbedded and/or molded into plastic and is located in at least one of the following locations: the bottom, the side, the lip.

17. The smart package of claim 1, further comprising at least one UV LED sheet that changes the design and/or colors of a said smart food package in at least one location.

18-71. (canceled)

72. A smart package including conductive ink printed upon a surface that can be placed and/or held in contact with the screen of a smart device and/or vending machine and/or device capable of sensing conducting and/or capacitive things and/or components and/or body parts.

73-76. (canceled)

77. A smart vending machine interface comprising of:
at least one capacitive touch point located on a front surface;
at least one element configured to communicate and/or read QR codes and/or other optical images; and
circuitry configured to decode and/or process at least one said touch point and/or said QR codes and/or other optical images.

78-97. (canceled)
